(19) United States
(12) Patent Application Publication
(10) Pub. No.: US 2022/0221395 A1
(43) Pub. Date: Jul. 14, 2022

(54) Device and Method for Testing Tack

(71) Applicant: LTS Lohmann Therapie-Systeme AG, Andernach (DE)

(72) Inventors: Thomas Hille, Neuwied (DE); Dieter Paulukat, Kruft (DE); Holger Schnabel, Frankfurt (DE)

(21) Appl. No.: 17/610,993

(22) PCT Filed: May 11, 2020
(86) PCT No.: PCT/EP2020/063075

§ 371 Date: Nov. 12, 2021

(30) Foreign Application Priority Data
May 14, 2019 (DE) 10 2019 112 619.3

(51) Int. Cl. G01N 19/04; G01N 3/08

(52) U.S. Cl. CPC G01N 19/04; G01N 3/08; G01N 2203/0252; G01N 2203/0091; G01N 2203/0676; G01N 2203/0017

(57) ABSTRACT

The disclosure relates to a testing device for testing tack, including: a test probe which has a test body; and a suspension which guides the test body, the suspension movably supporting the test body. The disclosure further relates to a testing machine for testing tack, including a measuring apparatus and a testing device of this type, which is connected to the measuring apparatus. Finally, the disclosure relates to a method for determining the tack. The method includes the steps of guiding a test probe of a test body onto a sample to be tested, placing the test probe onto the sample, lifting the test probe off of the sample, and sensing the force F as the test probe is lifted off.

### CROSS-REFERENCE TO RELATED APPLICATIONS

This application is the United States national phase of International Application No. PCT/EP2020/063075 filed May 11, 2020, and claims priority to German Patent Application No. 10 2019 112 619.3 filed May 14, 2019, the disclosures of which are hereby incorporated by reference in their entirety.

### BACKGROUND OF THE DISCLOSURE

The disclosure relates to a testing device for testing tack. In addition, the disclosure relates to a testing machine for testing tack comprising such a testing device. Further, the disclosure relates to a method for determining the tack.

### DESCRIPTION OF RELATED ART

The tack can be a physical-mechanical phenomenon, such as in the case of hook-and-loop fasteners, or the tack of a gecko foot, or it can be chemically induced. In particular, surfaces characterized by adhesivity are referred to as tacky. Tacky materials or structures or mixtures moreover possess large cohesive forces. Tacky materials are usually—but not generally—suitable as adhesives. For serving as an adhesive, the parts to be connected must be wetted with the substances.

A physically induced tack is usually obtained by the mechanical hooking and linking of fibrous surface structures.

In the case of reversible tack caused by pressure-sensitive adhesives, intermolecular interactions, such as Van-der-Waals forces or hydrogen bridge bonds are involved.

Pressure-sensitive adhesives are viscoelastic liquids which are both adhesive and cohesive. They are polymers with a glass transition temperature lying considerably below the room temperature, in particular acrylate copolymers, polysiloxanes or polyisobutylenes. It is crucial that they are liquids, although very viscous ones, since only liquids can have a wetting effect. This effect cannot be achieved with polymers in a glassy state.

The present disclosure addresses the testing or measuring of the tack. Particularly preferably, the disclosure addresses the testing or measuring of pressure-sensitive adhesives, wherein the disclosure does in particular not address the testing or measuring of physical tack.

An important field of application of pressure-sensitive adhesives involves medical plasters or dressings, for example. A plaster for a medical application is preferably a textile adhesive tape used for fixing purposes.

Thus, pressure-sensitive adhesives are in particular used within the framework of transdermal therapeutical systems (TTS) or transdermal plasters.

According to the European Pharmacopoeia Ph.Eur., TTS or transdermal plasters are to be understood as “. . . flexible, differently large pharmaceutical preparations containing one active agent or several active agents. [. . . ] When applied to the dry, clean and unwounded skin, the transdermal plaster adheres to the skin due to a slight pressure applied by hand or finger. The plaster can be removed from the outer carrier layer without any noticeable injury of the skin and without removing the preparation.”

There is a need for testing or measuring the tack of such systems, in particular of pressure-sensitive adhesives, particularly preferably pressure-sensitive adhesives for medical applications.

A method for measuring the tack is performed according to the American standard test method ASTM D 2979, also referred to as probe tack test. Here, the English term “tack” has been established. According to ASTM D, tack here in particular means the force required for peeling a body off a tacky surface after as short contact time.

The basic principle of the ASTM D test method is essentially as follows:

A test probe touches a pressure-sensitive surface in a very small area, ideally a point, and only for a short time, wherein a reversible connection is established between a test probe and a pressure-sensitive adhesive. Subsequently, a tensile testing machine measures the force required for separating the test probe and the pressure-sensitive adhesive. According to ASTM D 2979:

“4.1 This test method comprises establishing a contact between the tip of a cleaned test probe having a defined surface roughness and the adhesive at a controlled rate and at a defined pressure for a short time and at a defined temperature. Subsequently, the connection between the adhesive and the test probe is broken, also at a controlled rate. The tack is measured as a maximum force required for causing the connection to break.”

Here, the ASTM D 2979 test method has several drawbacks.

For example, the book of adhesive technology, considered the standard reference, Brockmann, W., Geiß, P. L., Klingen, J., Schröder, B., Klebetechnik-Klebstoffe, Anwendungen and Verfahren, Wiley-VCH Verlag GmbH & Co. KGaA, Weinheim, page 145 (2005) states in the chapter concerning test methods for pressure-sensitive adhesives:

“7.3.4.4 Probe tack (ASTM D 2979)”

One of the best science-based tests for determining the tack properties is the so-called probe tack test where a steel rod having a diameter of 5 mm and being end-faced is moved vertically towards the adhesive surface at a velocity of 10±0.1 mm/sec until, when the steel rod and the test strip contact each other, a force of 0.192 N is applied for a period of 1±0.001 sec. Then this steel rod must be immediately lifted off the adhesive surface at a velocity of 10±0.1 mm/sec. The value of the tack is the maximum force recorded when the steel rod and the adhesive surface are separated from each other. The test result may be used only when an adhesive failure occurs between the steel surface and the adhesive.

In principle, this test is carried out using static tensile testing machines, wherein the sample and the steel rod are fastened in the gripping heads of the machine. However, the time course of the test including advancing the rod, measuring the force and immediate lifting-off of the rod requires a control process and sensitive force measuring devices which are normally not provided in commercial testing machines. This applies in particular to the positioning force and to the timing of the reversal of the travel. Hence, special testing machines are required. Therefore, the test is normally not carried out in laboratories although it is doubtlessly the best experiment in terms of the mechanics of material testing, as long as care is taken that the stainless steel rod and its front end, respectively, are thoroughly cleaned before every new experiment.”

In Chuang, K. H., Chiu, C., Paniagua, R., Avery Adhesive Tester yields more performance data than traditional probe; presented at the Pressure Sensitive Tape Council's 20th annual technical seminar May 7-9, 1997 in Boston, USA, a modification of the probe tack test designated “Avery Adhesive Tester (ATT)” is presented which already uses a spherical test probe gripped by a lever device. The use of the lever allows for varying the force at which the test probe is placed onto the tacky surface. According to the authors, this force can be additionally changed in that a screw at the lever device can also change the distance to be traveled by the test probe before it is placed onto the tacky surface. This method, too, is disadvantageous in that too many machine parameters must be modified such that again special machines are required.

The authors of the American Pharmacopoeia, USP 41, too, take into account the advantages and disadvantages when, on the one hand, they mention the probe tack test as an example among other methods and, on the other hand, they do not commit themselves to the ASTM D 2979 method and leave it at the discretion of the TTS manufacturers to decide which method for determining the “tack” is most suitable.

### SUMMARY OF THE DISCLOSURE

It is an object of the disclosure to provide a testing device and a method, wherein the testing of tack is optimized.

According to the disclosure, the object is achieved by a testing device having the features of claim 1, a testing machine having the features of claim 10 as well as a method having the features of claim 13.

The device according to the disclosure is a testing device for testing tack. Here, testing in particular means the measurement of the tack, preferably as a force (in N), wherein the force preferably corresponds to “tack”. The testing device comprises a test body as well as a suspension for guiding the test body. The test body comprises at least one test probe for contacting the sample to be tested, wherein it is preferred that the test body is constituted by the test probe. Here, establishing of contact between the test probe and the sample preferably means placing the test body, in particular in the area of the test probe, onto the sample such that the test body rests on the sample in particular freely and thus preferably merely essentially influenced by gravity. The suspension movably supports the test body. Here, supporting in particular means arranging or guiding the test body in space. It is in particular preferred that the suspension supports the test body such that it is freely movable. Here, freely movable means that the test body is movable in and/or about at least one spatial direction, preferably in and/or about two spatial directions, and particularly preferred in and/or about three spatial directions. Here, spatial directions preferably are the directions along the three axes of the three-dimensional space. It is preferred that the suspension directly or indirectly connects the test body to a force meter. Here, it is preferred that this same connection is movable. According to a preferred embodiment, the suspension freely supports the test piece at least in the Z-direction, in particular in the positive Z-direction. If the suspension is a cord or a fiber, for example, wherein one end of the fiber or the cord is connected to the force meter and the other end is connected to the test body, for example, the test body can be moved in the positive Z-direction, in other words, upwards, for example. If in such an embodiment the test body is guided to a sample by the cord or the fiber and placed thereon such that the cord or the thread is no longer under tension due to the weight force of the test body, the test body freely rests on the sample.

It is preferred that the suspension comprises a joint. It is particularly preferred that the test body is supported on the joint with a degree of freedom of at least, in particular exactly, 1. For example, the joint can be a sliding joint or a rotary joint. Here, it is preferred that the joint allows for the test body to be freely placed onto the sample. It is preferred that here the definition of “joint” also includes a cord or a fiber.

It is preferred that the test body comprises a connecting device. The connecting device is connected, in particular integrally connected, to the test probe. The connecting device allows for a preferably detachable connection of the test probe to the suspension. It is preferred that the connecting device comprises a lug and/or a hook and is in particular constituted by the same.

In particular, the suspension comprises a bracket and is in particular constituted by the same. It is particularly preferred that the bracket is connected or connectable to the connecting device, in particular a lug and/or a hook. According to a preferred embodiment, the bracket of the suspension comprises metal, in particular high-grade steel, and is in particular made from the same. It is preferred that the hook is configured as a wire hook.

According to a preferred embodiment, the test probe comprises a spherical body and is in particular constituted by the same. Preferably, the spherical body is a sphere or a partial sphere, for example a hemisphere. The spherical body particularly advantageously ensures that the test probe touches the sample only at a point. This in particular solves the problem encountered in prior art, namely that prior art rod-shaped or tubular test probes comprise a touch area and thus do not allow for a touching at a point. The touch point in particular offers the advantage that a reproducible contact area is present on viscoelastic pressure-sensitive adhesives. This has so far not been possible due to the tip of the prior art test probe, in particular the non-reproducible immersing of the tip into the sample.

It is preferred that the spherical body configured as a sphere or a partial sphere has a diameter of approximately 2.5 cm, in particular 2.54 cm.

As an alternative to the spherical body, it is preferred that the test probe comprises a plate, preferably configured as a disk or a ring, and is in particular constituted by the same. Here, it is particularly preferred that the plate comprises a fixedly defined area, in particular a fixedly defined diameter, for touching the sample.

Preferably, the test probe comprises metal, in particular high-grade steel, and is preferably made from the same.

It is preferred that the test probe is coated. It is particularly preferred that the test probe has a predefined roughness, preferably produced by the coating. Preferably, the test probe is cleaned before the test, in particular with a solvent.

The testing machine according to the disclosure is a testing machine for testing tack, in particular a test bench for testing tack. The testing machine comprises a measuring unit, in particular a force measuring unit. Preferably, the measuring unit is a universal testing machine or a tabletop testing machine. On the other hand, the measuring unit can also be a hand-held force meter. According to a preferred embodiment, the measuring unit is a universal testing machine Z005 of Zwick/Roell. The testing machine further comprises a testing device connected to the measuring unit and having one or several of the features of the testing device according to the disclosure described above. The connection between the measuring unit and the testing device is preferably realized via the suspension of the testing device such that the suspension is connected to the measuring unit on the one side and to the test body on the other side.

According to a preferred embodiment, the testing machine, in particular the measuring unit, comprises a force meter, in particular a load cell. Here, it is preferred that the test body of the testing device or the test probe of the test body is movably connected to the force meter via the suspension.

It is preferred that the testing machine comprises a sample receiving portion. According to a preferred embodiment, the sample receiving portion comprises an essentially planar area which is preferably horizontally arranged. Here, the testing machine is in particular arranged such that above the sample receiving portion the force meter and the testing device connected thereto are arranged such that lowering of the testing device and thus in particular placing of the test probe onto a sample arranged on the sample receiving portion can be performed. A sample, such as a medical plaster, for example, can preferably be fixed to the sample receiving portion. Preferably, the sample receiving portion comprises a fixing device for fixing a sample. For example, the fixing device comprises an adhesive means, such as a double-sided adhesive tape, and is in particular constituted by the same. Preferably, fixing by means of a double-sided adhesive tape is realized such that the non-adhesive side of the plaster is connected to the sample receiving portion via the double-sided adhesive tape and thus the adhesive side of the plaster opposite the sample side faces a way from the latter such that the test probe can in particular contact the adhesive side. On the other hand or additionally, it is also possible that the fixing device comprises one or a plurality of detachable fixing elements, such as clamps. For example, the fixing device can comprise object clamps such as used for microscopes, for example. According to a preferred embodiment, the sample receiving portion comprises a T-bar and is in particular constituted by the same. Here, it is particularly preferred that the vertical portion of the T-bar is connected to the universal testing machine via clamping jaws, for example, and preferably the horizontal portion of the T-bar is configured for connection to the sample.

The method according to the disclosure is a method for determining tack, in particular of dermal adhesives, such as medical plasters and/or TTS, for example. Preferably, a force, in particular a “tack”, is determined. The method comprises the step of guiding a test probe of a test body to a sample to be tested. The step of guiding the test probe to the sample is in particular performed by essentially vertically guiding the test probe, wherein it is preferred that the test probe is guided starting from an initial state in which a specific distance to the sample of 100 mm, for example, exists. The test probe is preferably guided at a predefined velocity of 300 mm per minute, for example. A second step of the method is placing the test probe or the test body onto the sample. Preferably, the former is entirely placed onto the sample. Hence, the test probe or the test body freely rests on the sample after having been placed thereon such that the test probe or the test body is preferably merely influenced by its own weight force. Thus, the contact of the test probe or the test body and the sample to be tested, for example an adhesive strip to be tested, is in particular merely realized via the weight force of the test probe or the test body. Thereby, it is ensured in an advantageous manner that always the same force, namely the weight force of the test probe or the test body, is applied to samples whose tack is to be determined. Thereby, reproducible determinations or measurements of the tack are possible. In another step, the test probe or the test body is removed from, in particular lifted off, the sample. It is preferred that lifting of the test probe off the sample is performed by vertically lifting or pulling up the test probe or the test body. It is preferred that between placing, in particular complete placing, of the test probe onto the sample and lifting the test probe off the sample a predefined time of one second, for example, elapses, during which time the test probe or the test body freely rests on the sample. In the method, the force exerted for this purpose is sensed while the test probe is removed from or lifted off the sample. Particularly preferably, at least the maximum force is sensed while the test probe is lifted off the sample. In other words, the required lifting force, preferably the required maximum lifting force, is measured. Here, on the one hand, the measured force or the measured maximum force can be used as a measuring value of the tack or, on the other hand, it is possible that the measured forced or the measured maximum force serves as a starting basis for further calculations or ratings of the tack. Thus, it is possible to compare the measured forces of various samples and hence determine or define various tacks of the different samples.

According to a preferred embodiment, the method is performed by means of a testing device having one or several features of the testing device according to the disclosure described above and/or a testing machine having one or several features of the testing machine according to the disclosure described above.

In addition, it is preferred that to the method for testing tack one or several features described above with regard to the testing device or the testing machine are added. Likewise, it is preferred that to the testing device according to the disclosure and/or to the testing machine according to the disclosure one or several features of the method described above for determining tack, in particular within the framework of functional features, are added.

### BRIEF DESCRIPTION OF THE DRAWINGS

Hereunder the disclosure is described in detail on the basis of preferred embodiments with reference to the drawings in which:

FIGS. 1a and 1b schematically show prior art testing devices,

FIG. 2 shows a schematic view of a preferred embodiment of a testing device according to the disclosure,

FIG. 3 shows as schematic view of an embodiment of a testing machine according to the disclosure having a testing device according to the disclosure,

FIGS. 4a to 4e show schematic views of various preferred embodiments of test bodies according to the disclosure,

FIGS. 5a to 5d show schematic views of various preferred embodiments of test devices according to the disclosure, and

FIGS. 6a and 6b show schematic views of various preferred embodiments of sample receiving portions according to the disclosure for testing machines.

In the figures, identical components or elements are identified by the same reference numerals or variations thereof (for example 10 and 10). In particular, for the sake of clarity, elements already identified are preferably not provided with reference numerals in all figures.

### DETAILED DESCRIPTION

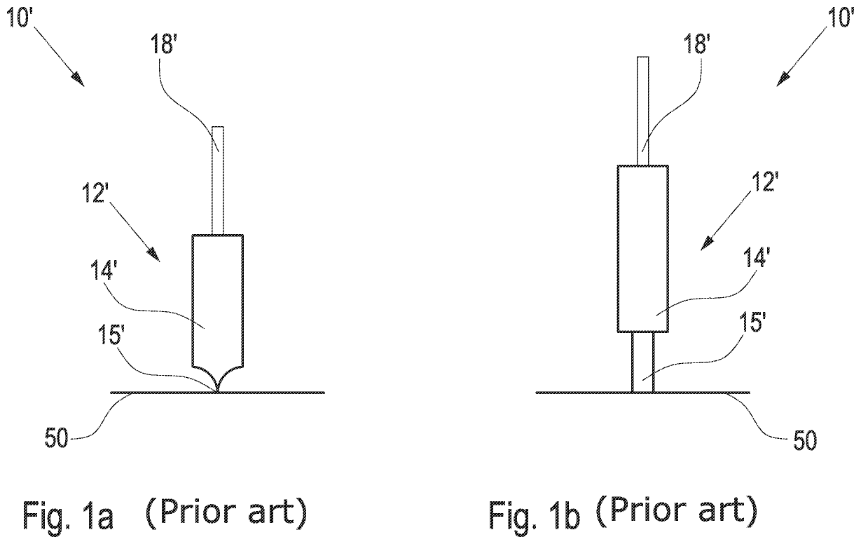

FIG. 1a shows an idealized prior art testing device 10′. The testing device 10′ comprises a test body 12′ which, in turn, comprises a test probe 14′. The test body 12′ is guided by means of a suspension 18′, wherein the connection between the suspension 18′ and the test body 12′ is configured as a fixed or rigid suspension.

The test body 12′ is illustrated with the test probe 14′ in contact with the sample 50 to be tested which is a plaster or TTS, for example. The contact between the test probe 14′ and the sample 50 is realized in a touch area or touch point 15′.

Due to the rigid connection and thus rigid guide of the test body 12′, the force between the test body 12′ and the sample 50 to be tested depends, in particular in the touch area 15′, on the force at which the test body 12′ is guided via the suspension 18′. Hence, if in various experiments the test probe 14′ contacts the sample 50 at different forces, this results in particular in different pressing forces in the contact area and/or different immersion depths.

According to prior art, it is ideally preferred that the tip of the test probe 14′ merely touches a single point. However, here an immersion and/or contact always occur at several points.

FIG. 1b shows a prior art test device 10′ as used in practice. Here, the test probe 14′ contacts or is immersed into the sample 50 in a contact area 15′ comprising a plurality of contact points, which results in a non-reproducible test.

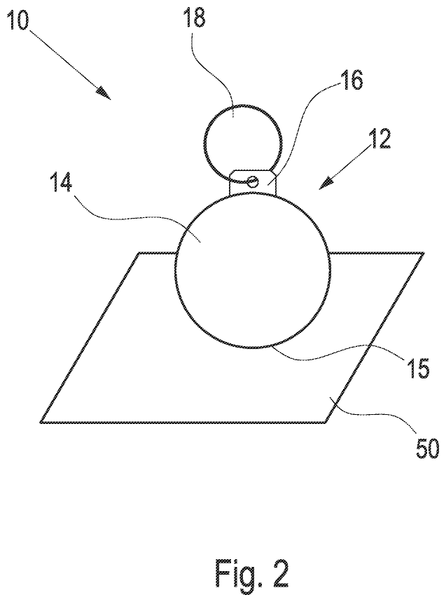

FIG. 2 shows an embodiment of a test device 10 according to the disclosure. The test device 10 comprises a test body 12. The test body 12 comprises a spherical test probe 14 as well as a lug 16 in particular integrally connected thereto.

The test body 12 is connected to the suspension 18 via the lug 16 which is a ring, in particular a metal ring, as illustrated. Since the suspension 18 is loosely or movably supported in the lug 16, the test body 12, when placed onto a sample 50, for example, completely freely rests on the sample 50 and is thus merely influenced by its own weight force.

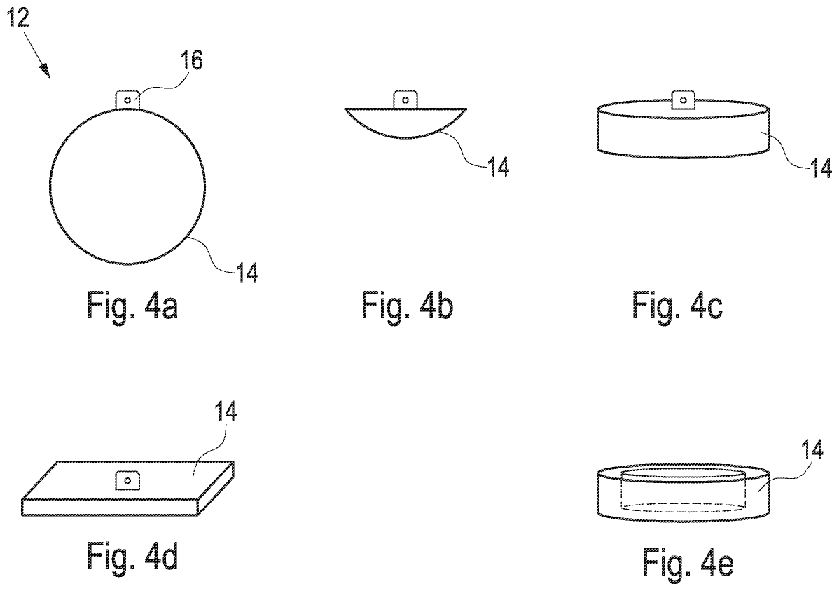

The advantage of the geometric shape of the test probe 14 as compared to prior art is obvious since no matter how the test probe 14 is placed onto the adhesive surface of the sample 50, the contact area 15 is always the same. In the case of a spherical shape of the test probe 14, as illustrated, the contact area 15 is a point or a small circle. The same applies to test probes 14 configured as spherical segments (see FIG. 4b, for example). In the case of test probes 14 of other geometrical shapes, for example, cylindrical, hollow-cylindrical or cuboidal, there are corresponding contact areas or immersion depths.

According to the disclosure, in particular the size of the contact area is thus always the same and reproducible and preferably exclusively depends on the viscosity of the adhesive surface and/or the weight force of the test probe.

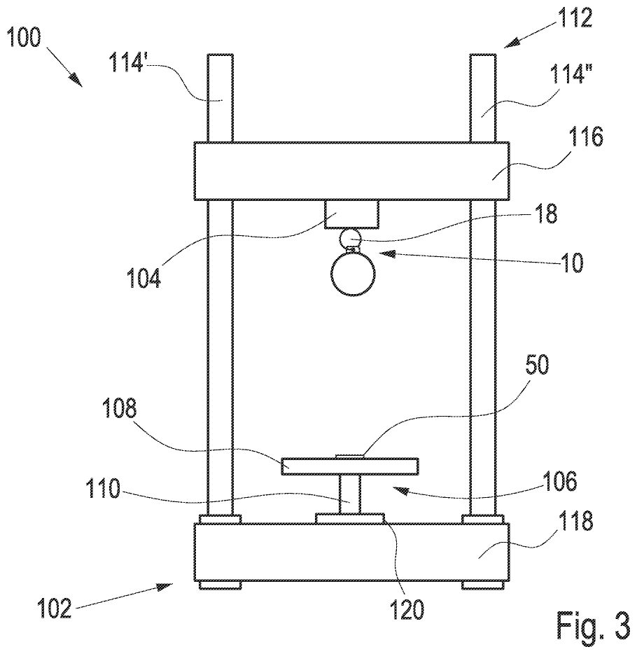

FIG. 3 shows a preferred embodiment of the disclosure of a testing machine 100.

The testing machine 100 comprises a measuring unit 102, in particular configured as a universal testing machine, such as a Z005 of Zwick/Roell, for example. The measuring unit 102 comprises a traverse 116 which is vertically displaceable along a guiding device 112. Two guiding bars 114′, 114″ of the guiding device 112 are shown. The traverse 116 can be displaced by an electric motor not shown, for example. The guiding bars 114′, 114″ end in a base body 118.

The displaceable traverse 116 has a force meter 104 connected thereto. The force meter 104 is in particular a load cell. To the force meter 104, in turn, a testing device 10 is connected via the suspension 18, wherein the testing device 10 is in particular configured like the testing device in FIG. 2.

The base body 118 has a sample receiving portion 106 connected thereto. The sample receiving portion 106 is illustrated as a T-bar having a horizontal plate 108 as well as a connecting column 110. The connecting column 110 is preferably connected to the base body 118 via a fixing means 120, such as clamping jaws of the measuring unit 102, for example.

A sample 50 is connected to the sample receiving portion 106, preferably via a double-sided pressure-sensitive adhesive tape.

Hence, the testing device 10 having the test probe 14 can contact the sample 50 by horizontally displacing the traverse 116. According to the disclosure, it is preferred here that the probe 14 is placed onto the sample 50 such that the suspension is free and thus not loaded. During a final vertical displacement in the opposite direction (upward) the lifting-off force, preferably the maximum lifting-off force, can be measured by the force meter 104 and thus the tack can be determined.

Another embodiment, not shown, according to the disclosure of the testing machine 100 comprises, similar to the embodiment of FIG. 3, a force meter 104 as well as a testing device 10 connected thereto. Such a testing machine 100 can be manually guided or operated, for example.

FIGS. 4a to 4e show various embodiments of the test body 12 according to the disclosure of the testing device 10.

FIG. 4 shows a spherical test probe 14 having a lug 16 connected thereto.

Instead of the spherical configuration an oval configuration is also possible, for example.

FIG. 4b shows a test probe 14 configured as a partial sphere. As illustrated, this is approximately a quarter sphere, wherein hemispheres or three quarters of a sphere etc. are also possible, for example.

FIG. 4c shows an embodiment of the test probe 14 configured as a round disc or a round cylinder.

FIG. 4d shows an embodiment of the test probe 14 configured as a plate or a cuboid.

FIG. 4e shows an embodiment of the test probe 14 configured as a hollow cylinder. Here, FIG. 4e does not show a lug 16 or the like. Here, it is possible to arrange, in the upper base area of the hollow cylinder, a plurality of lugs or other connecting devices for connecting to a suspension, for example.

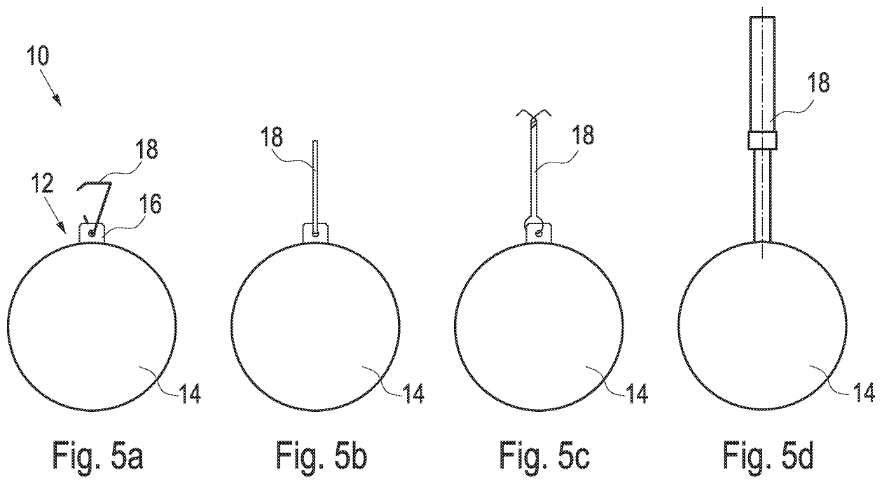

In FIGS. 5a to 5d testing devices 10 having different preferred embodiments of suspensions 18 are illustrated.

FIG. 5ashows a suspension 18 comprising a hook, preferably a metal hook, particularly preferably a wire hook.

In FIG. 5b, the suspension 18 comprises a cord or a fiber and is in particular constituted by the same.

FIG. 5c shows a suspension 18 having a loop, preferably a wire loop.

In FIG. 5d, the suspension 18 comprises a telescopic suspension made up of two telescopic members, as illustrated.

In contrast to the embodiments of FIGS. 5a to 5c, the embodiment of FIG. 5d does not comprise a lug 16 of the test body 12 for connection to the suspension 18, but the telescopic suspension 18 is directly, preferably integrally, connected to the test probe 14.

In FIGS. 5a to 5d the test body 12 always comprises a spherical test probe 14. Of course, other embodiments, in particular the embodiments of FIGS. 4a to 4e, of the test probe 14 in combination with each embodiment of the suspension, preferably of FIGS. 5a to 5d, are feasible.

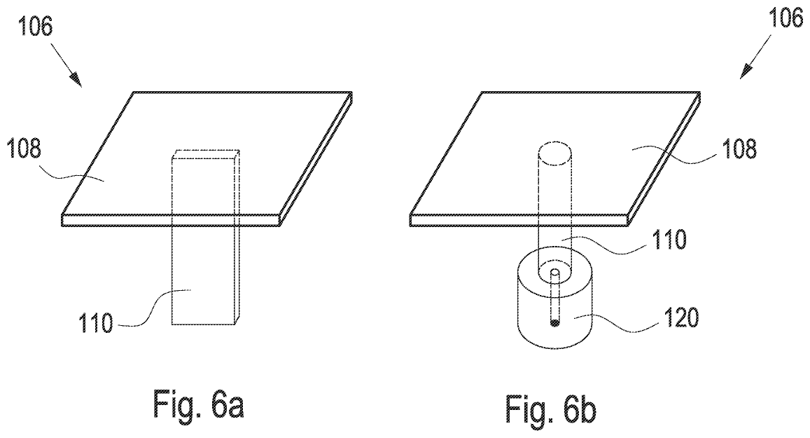

In FIGS. 6a and 6b two preferred embodiments of sample receiving portions 106 according to the disclosure for testing machines 100 are illustrated.

FIG. 6a shows an embodiment of the sample receiving portion 106 which essentially corresponds to the embodiment of the sample receiving portion 106 of FIG. 3. The sample receiving portion 106 comprises a T-bar having a horizontal plate 108 as well as a connecting column 110.

FIG. 6b shows an embodiment of the sample receiving portion 106 having a horizontal plate 108 as well as a cylindrical connecting column 110. The connecting column 110 is supported in a displaceable fixing device 120, preferably a ball joint fixing device 120, such that the sample receiving portion 106 can be fixed or arranged in various positions.

The method according to the disclosure for determining tack is preferably performed by means of devices illustrated in the Figures, or to which one or several features of the Figures are added.

Hereunder the present disclosure will be exemplified on the basis of a performed experiment.

### EXPERIMENT EXAMPLE

The illustrated experiment example illustrates, on the one hand, a prior method for testing tack within the framework of the probe tack test (ASTM D 2979) as well as an embodiment of a method according to the disclosure for testing tack using an embodiment of a testing machine according to the disclosure having an embodiment of the testing device according to the disclosure.

### Materials and Methods

Hereunder the materials and methods used are illustrated.

1.1 Materials

Per n=6 commercially available TTS the prior art method for probe tack test (ASTM D 2979) was performed and the tack was checked.

TTS containing acrylate copolymers, polysiloxanes or polyisobutylenes were tested as samples. The trade names, batch codes and polymers are stated in Table 1:

TABLE 1
Three over-the-counter Nicotin TTS and one rivastigmine
TTS only available on prescription for measuring the tack

| Trade name | Batch code | Polymer |
|---|---|---|
| Nicotinell ® | 81218417 | Neutral acrylate vinyl acetate copolymer |
| Niquitin ® | 1609890 | Polyisobutylene |
| Nicorette ® | 81216016 | Acidic acrylate vinyl acetate copolymer |
| Exelon ® | 835220 | Polysiloxane |

1.2 Methods

1.2.1 Prior art method (probe tack test: ASTM D 2979)

First, the experiment was carried out by means of the prior art method for probe tack test ASTM D 2979 (test results see Table 2).

1.2.2 Method of the illustrated experiment according to the disclosure

1.2.2.1 Definition

The tack is the force required for removing a body from an adhesive surface after a short contact time.

1.2.2.2 Pretreatment of the samples

Subsequently, the experiment was carried out using an embodiment of the testing machine according to the disclosure having a testing device according to the disclosure within the framework of an embodiment of the method according to the disclosure, as described below.

Prior to the test the samples were stored under the following conditions in a controlled thermal environment for at least 24 hours: Temperature: 23° C.±2° C. Relative humidity: 50% ±5% (abs.)

1.2.2.3 Preparation of the experiment

The following preparations of the experiment described below were made.

1.2.2.3.1 Devices and materials used
Universal testing machine: Z005, Zwick/Roell
Wire hook for suspending the test body from the load cell according to the embodiment of FIG. 5a
Test body: Test probe configured as a polished solid steel sphere Diameter=2.54 cm with suspension lug (in particular according to the embodiment of FIG. 5a)
Double-sided pressure-sensitive adhesive tape: Duplocoll 365, Lohmann Neuwied, for fastening the samples to the sample receiving portion
Sample receiving portion: T-bar according to the embodiment of FIG. 6a
Solvent for cleaning the test body (e.g. special benzine 80/110, ethyl acetate, . . . )
Lintfree cloth for cleaning the test body (e.g. from cotton wool or cellulose).

The experiment setup essentially corresponds to the setup of FIG. 3, however, in particular having a wire hook instead of the ring as a hanger.

1.2.2.3.2. Preparation

The testing machine was set up as follows: The test body is cleaned with a suitable solvent and suspended in the load cell. A T-bar is fixed to the lower clamping jaw. The force indicator is set to zero. The test body is manually moved downward to such an extent that it slightly touches the plate of the T-bar. Now the actual distance is set to zero. The initial distance is approached again using the LE button. The distance between the T-bar and the test body is measured again (desired value: 100 mm).

For example, the following parameters are to be entered as test parameters (depending on machine type, test body and suspending device):
LE=100 mm/min. (distance between T-bar and test body)
Measurement path=10 mm
Test velocity=300 mm/min.
Clamping length after pre-travel=0 mm
Velocity pre-travel=300 mm/min.
Dwell time after pre-travel=1 sec

1.2.2.4 Measurement

The sample is fixed to the T-bar by means of a double-sided pressure-sensitive adhesive tape with the adhesive side facing upward, and any protective film is peeled off.

After the sample has been fixed the measurement is started using the start button.

1.2.2.5 Evaluation

The maximum value during the measurement (Fmax) is stated as the measured value. After completion of the measurement the mean of the individual values of the maxima is taken by the test program, and the mean value, the standard deviation and the relative standard deviation in % are taken.

This yielded the following results:

TABLE 2
Tack according to experiment as per ASTM D 2979

| | | | Nicotinell ®, | |
|---|---|---|---|---|
| | | Nicorette ®, | TTS from | |
| | Exelon ®, | TTS from | neutral | |
| | TTS | acidic acrylate | acrylate | Niquitin ®, |
| Adhesive | from poly- | vinyl acetate | vinyl acetate | TTS from poly- |
| Sample | siloxane | copolymer | copolymer | isobutylene |
| 1 | 2.74N | 3.09N | 6.02N | 0.42N |
| 2 | 2.96N | 2.96N | 3.82N | 0.47N |
| 3 | 2.88N | 2.66N | 4.90N | 0.35N |
| 4 | 2.54N | 3.72N | 6.05N | 0.42N |
| 5 | 3.29N | 2.84N | 5.27N | 0.24N |
| 6 | 3.18N | 2.68N | 5.92N | 0.25N |
| MW | 3.10N | 2.99N | 5.33N | 0.36N |
| S | 0.29N | 0.39N | 0.88N | 0.10N |
| S rel | 9.5% | 13.1% | 16.4% | 26.7% |

TABLE 3
Tack in accordance with the illustrated experiment
setup according to the disclosure.

| | | | Nicotinell ®, | |
|---|---|---|---|---|
| | | Nicorette ®, | TTS from | |
| | Exelon ®, | TTS from | neutral | |
| | TTS | acidic acrylate | acrylate | Niquitin ®, |
| Adhesive | from poly- | vinyl acetate | vinyl acetate | TTS from poly- |
| Sample | siloxane | copolymer | copolymer | isobutylene |
| 1 | 2.53 N | 3.62 N | 3.73 N | 0.32 N |
| 2 | 3.03 N | 3.21 N | 3.92 N | 0.22 N |
| 3 | 2.63 N | 3.63 N | 4.13 N | 0.23 N |
| 4 | 2.81 N | 3.42 N | 4.58 N | 0.24 N |
| 5 | 2.39 N | 3.46 N | 4.72 N | 0.39 N |
| 6 | 2.75 N | 3.58 N | 4.82 N | 0.21 N |
| MW | 2.69 N | 3.49 N | 4.32 N | 0.27 N |
| S | 0.23 N | 0.16 N | 0.45 N | 0.07 N |
| S rel | 8.4% | 4.6% | 10.5% | 26.9% |

The statistical results were calculated from the non-rounded raw data.

Although the illustrated experiment setup according to the disclosure was realized using a standard testing machine (Z005), the achieved results lie in the range of the results achieved by means of the special machine for the probe tack test (ASTM D 2979). It is however noticeable that the scattering, expressed by the relative standard deviations, at the values achieved by the less complex methods and devices is either considerably lower, but in no case worse than the scattering of the probe tack test (ASTM D 2979). This illustrates advantages offered by the disclosure.

1. A testing device for testing tack, comprising
a test probe comprising a test body and a suspension guiding the test body,
wherein the suspension supports the test body.

2. The testing device according to claim 1, wherein the suspension freely supports the test body in a Z-direction.

3. The testing device according to claim 1, wherein the suspension comprises a joint.

4. The testing device according to claim 3, wherein the joint supports the test body with a degree of freedom of at least 1.

5. The testing device according to claim 1, wherein the suspension comprises a bracket connectable to a lug of the test probe.

6. The testing device according to claim 1, wherein
the test probe comprises a spherical body and is constituted by the same.

7. The testing device according to claim 1, wherein the test probe comprises a plate and is constituted by the same.

8. The testing device according to claim 1, wherein the test probe and/or the bracket comprise metal and is made from the same.

9. The testing device according to claim 1, wherein the test probe is coated and/or polished and/or cleaned with a solvent.

10. A testing machine for testing tack, comprising a measuring unit and a testing device connected to the measuring unit, according to claim 1.

11. The testing machine according to claim 10, further comprising
a force meter,
wherein the test probe is movably connected to the force meter via the suspension.

12. The testing machine according to claim 10, further comprising a sample receiving portion.

13. A method for determining tack comprising the steps of:
(a) guiding a test probe of a test body onto a sample to be tested,
(b) placing the test probe onto the sample,
(c) lifting the test probe off the probe, and
(d) sensing the force F when lifting off the test probe.

14. The method according to claim 13, wherein the method is carried out by a testing device according to claim 1.

15. The testing device according to claim 1, wherein the test probe comprises a disc or a ring, and is constituted by the same.

16. A testing machine for testing tack, comprising a force measuring unit, and a testing device connected to the measuring unit, according to claim 1.

17. The testing machine according to claim 10, further comprising a load cell wherein the test probe is movably connected to the force meter via the suspension.

18. The testing machine according to claim 10, further comprising a T-bar.

19. A method for determining tack of dermal adhesives, comprising the steps of:
(a) guiding a test probe of a test body onto a sample to be tested,
(b) completely placing the test probe onto the sample,
(c) lifting the test probe off the probe, and
(d) sensing the maximum force Fmax, when lifting off the test probe.

20. The method according to claim 13, wherein the method is carried out by a testing machine according to claim 10.
